(19) United States
(12) Patent Application Publication
(10) Pub. No.: US 2026/0238578 A1
(43) Pub. Date: Aug. 13, 2026

(54) SIGNALING AND DETERMINING BURST INFORMATION FOR COMMUNICATION SESSIONS USING QUIC TRANSPORT

(71) Applicant: QUALCOMM Incorporated, San Diego, CA (US)

(72) Inventors: Liangping Ma, San Diego, CA (US); Thomas Stockhammer, Bergen (DE); Imed Bouazizi, Celina, TX (US); Nikolai Konrad Leung, San Francisco, CA (US)

(21) Appl. No.: 19/536,878

(22) Filed: Feb. 11, 2026

Related U.S. Application Data
(60) Provisional application No. 63/759,647, filed on Feb. 18, 2025.
(60) Provisional application No. 63/758,088, filed on Feb. 13, 2025.

(51) Int. Cl. H04L 43/0852; H04L 47/10

(52) U.S. Cl. CPC H04L 43/0852; H04L 47/10

(57) ABSTRACT

An example device for receiving data via a network includes: a memory configured to store data; and a processing system implemented in circuitry, the processing system including reception circuitry, the processing system being configured to: receive, via the reception circuitry, data representing a time between a time of transmission of a previous QUIC packet and a time of transmission of a subsequent QUIC packet; after receiving the previous QUIC packet, disable the reception circuitry for an idle time period according to the data representing the time between the time of transmission of the previous QUIC packet and the time of transmission of the subsequent QUIC packet; after the idle time period, enable the reception circuitry; and after enabling the reception circuitry, receive, via the reception circuitry, the subsequent QUIC packet.

### CROSS-REFERENCE TO RELATED APPLICATION(S)

This application claims the benefit of U.S. Provisional Application No. 63/758,088, filed February 13, 2025, and of U.S. Provisional Application No. 63/759,647, filed February 18, 2025, the entire contents of each of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging data via a network, such as media data. The network may be a radio access network (RAN), such as a 5G network. Media data, such as video data, may take variable amounts of time to encode and transmit. For example, a frame of video data following a scene change may require more time to encode than a frame of video data following another frame of the same scene. Thus, predicting precise timing between packets of data sent via the network may be difficult when the packets include frames of video data.

Therefore, rather than signaling a precise time to next burst (TTNB) value, the techniques of this disclosure include signaling a minimum time between a time of transmission of a previous packet and a time of transmission of a subsequent packet. In this manner, the sender may determine a minimum amount of time required to, e.g., encode and send packets corresponding to various frames of video data and signal this minimum amount of time. Therefore, a client device or other receiving device may deactivate reception circuitry to save power, while also enabling the reception circuitry at a time at which the subsequent packet is to be received. As such, signaled times between packets may be reduced, thereby reducing latency for transmissions, while also preserving the ability of the client device to save power between packet transmissions. Such signaled times may be applied to QUIC packets per the techniques of this disclosure.

In one example, a method of receiving data via a network includes: receiving data representing a time between a time of transmission of a previous QUIC packet and a time of transmission of a subsequent QUIC packet; after receiving the previous QUIC packet, disabling reception of data for an idle time period according to the data representing the time between the time of transmission of the previous QUIC packet and the time of transmission of the subsequent QUIC packet; after the idle time period, enabling reception of data; and after enabling reception of data, receiving the subsequent QUIC packet.

In another example, a device for receiving data via a network includes: a memory configured to store data; and a processing system implemented in circuitry, the processing system including reception circuitry, the processing system being configured to: receive, via the reception circuitry, data representing a time between a time of transmission of a previous QUIC packet and a time of transmission of a subsequent QUIC packet; after receiving the previous QUIC packet, disable the reception circuitry for an idle time period according to the data representing the time between the time of transmission of the previous QUIC packet and the time of transmission of the subsequent QUIC packet; after the idle time period, enable the reception circuitry; and after enabling the reception circuitry, receive, via the reception circuitry, the subsequent QUIC packet.

In another example, a method of sending data via a network includes: sending a previous QUIC packet of a QUIC packet flow to a client device; determining a time between a time of transmission of the previous QUIC packet and a time of transmission of a subsequent QUIC packet of the QUIC packet flow; sending data representing the time between the time of transmission of the previous QUIC packet and the time of transmission of the subsequent QUIC packet to the client device; and at or after a time corresponding to a time following the time between the time of transmission of the previous packet and the time of transmission of the subsequent QUIC packet, sending the subsequent QUIC packet to the client device.

In another example, a device for sending data via a network includes: a memory configured to store data; and a processing system implemented in circuitry and configured to: send a previous QUIC packet of a QUIC packet flow to a client device; determine a time between a time of transmission of the previous QUIC packet and a time of transmission of a subsequent QUIC packet of the QUIC packet flow; send data representing the time between the time of transmission of the previous QUIC packet and the time of transmission of the subsequent QUIC packet to the client device; and at or after a time corresponding to a time following the time between the time of transmission of the previous packet and the time of transmission of the subsequent QUIC packet, send the subsequent QUIC packet to the client device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a block diagram illustrating an example set of network devices that may perform various aspects of the techniques of this disclosure.

FIG. 4 is a conceptual diagram illustrating packet structures for packets sent between various network devices.

FIG. 5 is a conceptual diagram illustrating an example QUIC packet.

FIGS. 6A and 6B are conceptual diagrams illustrating examples of modified QUIC packets for signaling data burst information per techniques of this disclosure.

FIGS. 7A and 7B are conceptual diagrams illustrating example RTP header extensions for signaling dynamically changing traffic characteristic indications for one- and two-byte RTP header extension formats.

FIG. 8 is a flowchart illustrating an example method of constructing and sending a QUIC packet including a QUIC packet header extended per techniques of this disclosure.

FIG. 9 is a flowchart illustrating an example method of receiving and using a QUIC packet including a QUIC packet header extended per techniques of this disclosure.

### DETAILED DESCRIPTION

In general, this disclosure describes techniques for transmitting data via a network, such as a radio access network (RAN). In some techniques, a data burst is defined as a set of multiple protocol data units (PDUs) generated and sent by an application such that there is an idle period between two data bursts. A data burst can include one or more PDU Sets.

Indications of data burst characteristics (such as burst size and time to next burst (TTNB)) are intended to be exposed to intermediate network devices (e.g., intermediate routers) between a sending device and a receiving device. Indications of data burst characteristics (such as burst size, time to next burst (TTNB), and/or data boosting indication) are intended to be exposed to intermediate network devices (e.g., intermediate routers) between a sending device and a receiving device. A user plane function (UPF) device may be one of the intermediate network devices. Exposure of the data burst characteristics to the intermediate network devices is intended to allow for cross-layer optimization. For example, in a cellular downlink: an application server device may send an RTP packet whose RTP header extension indicates data burst information. A UPF device may extract the data burst information from the RTP header extension of the RTP packet that carries the indications, copy the information into a General Packet Radio Service (GPRS) Tunneling Protocol User Data (GTP-U) packet header of a GTP-U packet that encapsulates the RTP packet, and send the GTP-U packet to a base station of a radio access network (RAN) via a network tunnel. The base station may use the data burst information of the GTP-U packet header for scheduling and UE power savings configurations.

In some techniques, a TTNB value represents a time interval between transmission of a last packet in a current burst and a first packet of a next burst, i.e., inter-burst time. This disclosure recognizes that this definition of TTNB may result in problems in some cases. For example, when transmitting live video data (i.e., video data being recorded in real time), the video encoding time can be highly variable and rate adaptation can change a time when the next frame can be generated. Therefore, it may be difficult for the sending device to determine precisely when the first packet of the next burst will be created.

This disclosure describes techniques that may be used to address timing uncertainty at the sending device side due to application layer behavior (e.g., multimedia encoding, congestion control, and/or rate control). Per techniques of this disclosure, an idle period (i.e., a time between transmission of data bursts) may be defined that is more general than the conventional TTNB value. Attributes for data bursts may include burst identifiers, and the idle period concept of this disclosure may be used without the context of a data burst. For example, if a data burst is relatively long, e.g., 6 ms, the idle period may signal a time gap within the data burst, which can help with client device (e.g., user equipment (UE) device) power saving. For TTNB, the idle period may be particularized to retain its ability to handle timing uncertainty.

Per this disclosure, an idle period may be defined as a time period during which the sending device will not send (transmit) any packet, where the starting point of the idle time period may be the time of transmission of the packet that carries the idle period indication. The idle period may therefore serve as a lower bound on the time period during which no traffic leaves the sending device. The idle period may be considered as a guaranteed time period during which no traffic leaves the sending device. The idle period may, additionally or alternatively, be considered as a minimally guaranteed time period during which no traffic leaves the sending device. Alternatively, the idle period may be considered as a time threshold below which no traffic leaves the sending device. Thus, it is possible that the sending device may continue to refrain from sending traffic after the idle period. The idle period may be applied to data bursts to redefine the TTNB value, such that a redefined TTNB value per these techniques is a lower bound on the amount of time to be elapsed from the transmission of the last packet in the current data burst to the transmission of the first packet of the next burst. To increase the benefit of signaling idle period, a traffic sender may determine a value as large as possible for the idle period, e.g., the largest lower bound.

In this manner, the idle period definition or the newly defined TTNB value may easily allow the sending device to account for delays between packets, e.g., video encoding delay, which is variable even if video frame rate is constant. For example, assuming the video encoding delay varies from 1 to 3 ms, the nominal frame rate is 60 fps, and the spread of packets of a frame is negligible, with the conventional definition of TTNB, it would be difficult for the sending device to determine when the next frame will be sent out. However, per techniques of this disclosure, for example, the sending device may determine a maximum extra encoding delay of 2 ms and a time between frames of 16.67 ms, then signal the difference as 14.67 ms (16.67 ms–2 ms) as a lower bound on the minimum time between packet bursts.

As such, the idle period may represent a lower bound on an amount of time that a sending device guarantees no traffic will be sent to the network. This may be beneficial because it is generally difficult for the sending device to predict when multimedia encoding, such as video encoding, will be completed for a particular data burst/subsequent packet. Conventional TTNB, redefined TTNB, and/or idle period data for traffic timing information may be used for techniques of this disclosure.

Furthermore, while RTP is often used to transfer media data via a network, another transmission protocol is QUIC, per Iyengar et al., “QUIC: A UDP-Based Multiplexed and Secure Transport,” Internet Engineering Task Force (IETF), RFC 9000, May 2021, available at datatracker.ietf.org/doc/html/rfc9000. This disclosure describes techniques that may be used with QUIC to signal, e.g., the idle period data as discussed above. This disclosure recognizes that QUIC is end-to-end encrypted. Thus, this disclosure describes techniques by which idle period data/lower bound on the time between packets/bursts data may be signaled when using QUIC for transport of, e.g., encoded video data. Per this disclosure, burst information may be signaled in an unencrypted manner, where the burst information may include conventional TTNB data, the redefined TTNB value, and/or the idle period value, along with burst size information.

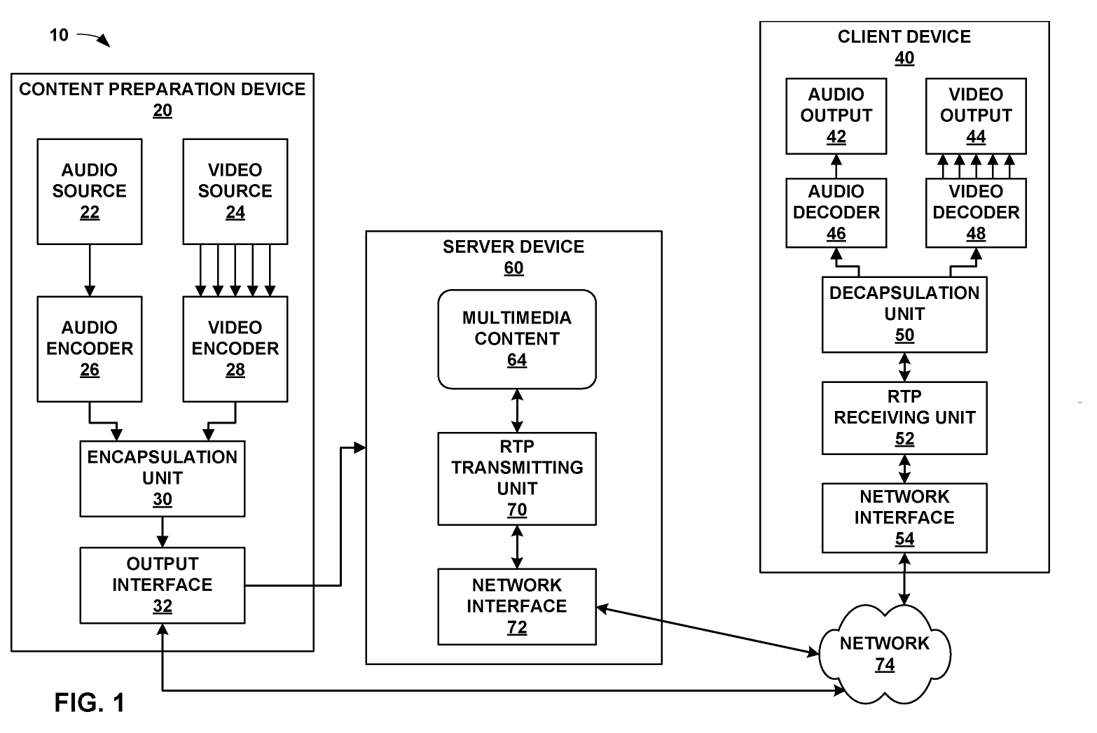

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and Supplemental Enhancement Information (SEI) NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of Scalable Video Coding (SVC) and view scalability information SEI messages in Multiview Video Coding (MVC). These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet Protocol (IP). Thus, in some examples, server device 60 may send media data via RTP and RTSP over UDP using network 74.

In accordance with the techniques of this disclosure, server device 60 may operate as a device for sending data via a network. For example, server device 60 may send a previous QUIC packet of a QUIC packet flow to client device 40. Server device 60 may determine a time between a time of transmission of the previous QUIC packet and a time of transmission of a subsequent QUIC packet of the packet flow (e.g., based on video encoding delays from video encoder 28). Server device 60 may send data representing this time difference to client device 40. In some examples, server device 60 sends this data in an unencrypted portion of a QUIC header of the previous QUIC packet, which may precede an encrypted portion of the QUIC header of the previous QUIC packet. The data may define an idle time period as a lower bound on the time between transmissions, or a time to next burst (TTNB) value. Server device 60 may use a flag bit in the previous QUIC packet to indicate the presence of this data. At or after a time corresponding to the time following the time between the time of transmission of the previous packet and the time of transmission of the subsequent QUIC packet, server device 60 may send the subsequent QUIC packet to client device 40.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

By encapsulating a QUIC packet with a QUIC header extension including data representing the time between the transmission time of the QUIC packet and the transmission time of the subsequent QUIC packet per the techniques of this disclosure, server device 60 may enable client device 40 to effectively manage power consumption. Specifically, data defining the idle time period may allow client device 40 to disable reception circuitry with the assurance that no data will be transmitted during the idle period. Disabling the reception circuitry during the defined idle time period may reduce power consumption of client device 40 compared to maintaining the reception circuitry in an active state. Furthermore, signaling this time as a minimum time or lower bound, rather than a precise time to next burst, may allow server device 60 to account for variable encoding times (e.g., video encoding delays) while still providing client device 40 with actionable timing information for power saving. Additionally, providing this information in an unencrypted portion of the QUIC header allows network devices to access traffic characteristics for optimization without requiring decryption of the payload. In this manner, intermediate devices, such as a user plane function (UPF) device and a base station, may access such data and use this data accordingly.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

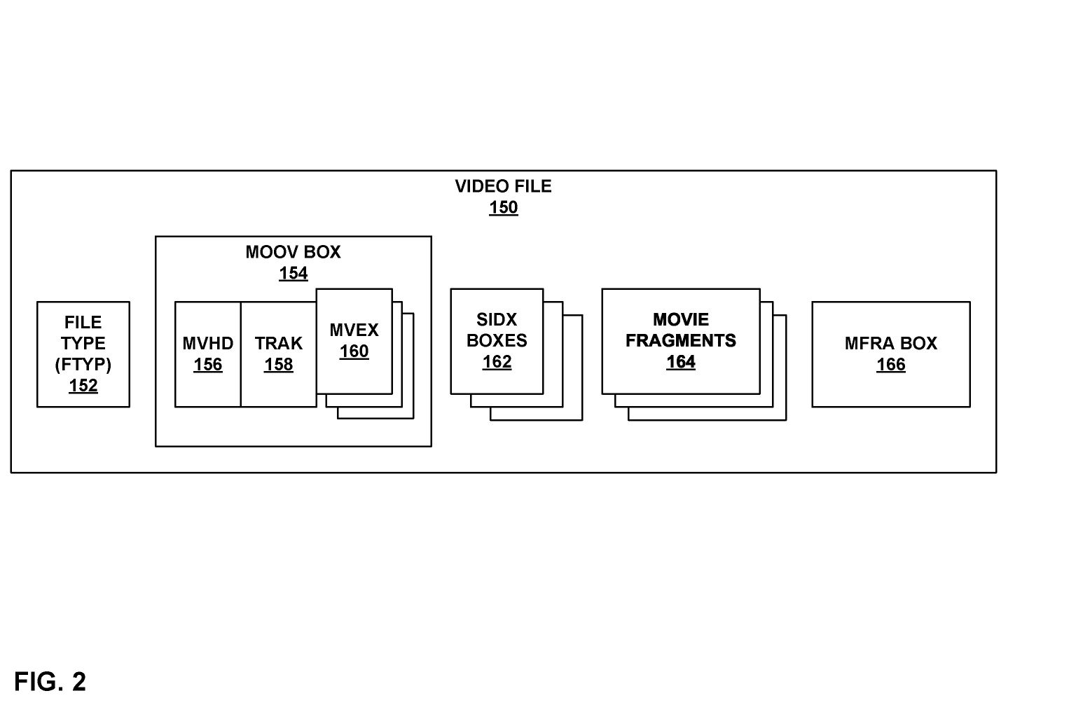

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend on SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

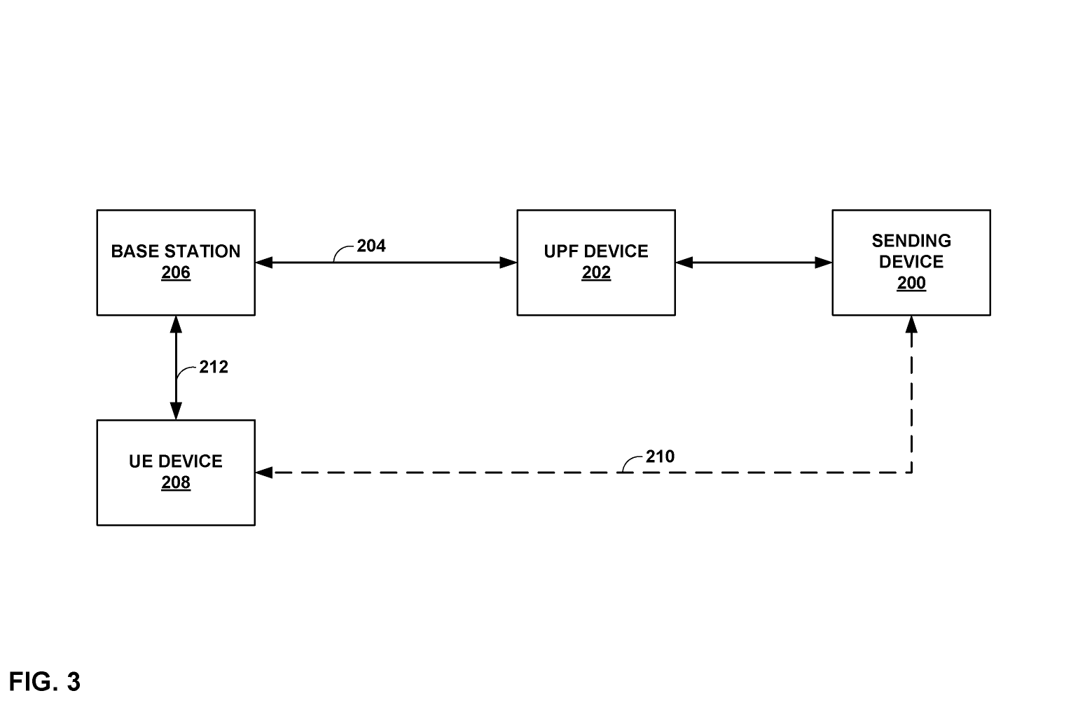

FIG. 3 is a block diagram illustrating an example set of network devices that may perform various aspects of the techniques of this disclosure. The example of FIG. 3 depicts sending device 200, user plane function (UPF) device 202, base station 206, and user equipment (UE) device 208. Sending device 200 may correspond to server device 60 and/or content preparation device 20 of FIG. 1. UE device 208 may correspond to client device 40 of FIG. 1.

Sending device 200 (e.g., an application server (AS) device) may obtain video data to be sent to UE device 208 via communication session 210. To send the video data to UE device 208, sending device 200 may encode the video data (or receive encoded video data from an encoding device, not shown in FIG. 3). Sending device 200 may encapsulate packets including encoded video data (e.g., encoded slices of frames of video data) to form real-time transport protocol (RTP) packets. Sending device 200 may add an RTP extension header to the RTP packets, where the RTP extension header includes data representing an idle period indicating a lower bound on a time between a time of transmission of a current RTP packet and a time of transmission of a subsequent RTP packet. As the RTP packets are formed, sending device 200 may send the RTP packets to UE device 208 via a network including UPF device 202. Although not shown in FIG. 3, there may be additional network devices between sending device 200 and UPF device 202, e.g., various network routing devices, gateways, bridges, switches, or the like.

UPF device 202 may receive the RTP packets from sending device 200 and form GTP-U tunneled packets. For example, UPF device 202 may encapsulate the RTP packets with respective GTP-U headers. Per techniques of this disclosure, UPF device 202 may extract the lower bound on the time value from the RTP header extensions of the RTP packets and timestamps indicating times at which the RTP packets were transmitted by sending device 200, e.g., from respective RTP header extensions. UPF device 202 may also compare differences between the timestamps to differences between times of reception of the packets to measure network jitter. UPF device 202 may then form the GTP-U headers to include a modified idle period time according to the signaled lower bound on the time values and the network jitter. UPF device 202 may send the GTP-U packets to base station 206 via network tunnel 204. Network tunnel 204 may include other network devices, such as network routing devices, configured to forward the GTP-U packets along network tunnel 204 to base station 206.

Base station 206 may receive the GTP-U packets and decapsulate the GTP-U packets to reproduce the RTP packets. Base station 206 may allocate resources to reception of the GTP-U packets based on the modified idle time period. Base station 206 may then send the RTP packets to UE device 208 via radio access network (RAN) connection 212.

UE device 208 may receive the RTP packets from base station 206 via RAN connection 212. In particular, UE device 208 may be a battery powered device, such as a cellphone. Thus, to preserve battery power, UE device 208 may disable reception of packets for communication session 210 via RAN connection 212 for idle period times indicated by the lower bound on the time between time of transmission of a previous packet and time of transmission of a subsequent packet of communication session 210. For example, during the idle period times, UE device 208 may power down reception circuitry, then power up the reception circuitry at the end of the idle period.

Sending device 200 may operate as a device for sending data via a network. Sending device 200 may determine a time between a time of transmission of a QUIC packet (e.g., a current QUIC packet) and the time of transmission of a subsequent QUIC packet. In some examples, sending device 200 calculates the time between the time of transmission of the current QUIC packet and the time of transmission of the subsequent QUIC packet according to a video encoding delay, where the current QUIC packet includes encoded video data of a media presentation and the subsequent QUIC packet includes subsequent encoded video data of the media presentation. Sending device 200 may encapsulate the current QUIC packet with data representing the time between the time of transmission of the current QUIC packet and the time of transmission of the subsequent QUIC packet to UE device 208.

For example, sending device 200 may send the data representing the time in an unencrypted portion of a QUIC header of the current QUIC packet. The data may define an idle time period representing a lower bound on the time between the time of transmission of the previous QUIC packet and the time of transmission of the subsequent QUIC packet, or a time to next burst (TTNB) value. Sending device 200 may also set a flag bit in the current QUIC packet having a value indicating that the data representing the time is present. At or after a time corresponding to the time following the time between the time of transmission of the previous packet and the time of transmission of the subsequent QUIC packet, sending device 200 sends the subsequent QUIC packet to the client device.

Base station 206 may use this data of the current QUIC packet to configure UE device 208 to disable reception circuitry for an idle time, i.e., a time between the time at which the current QUIC packet is received via communication session 210 and the time at which the subsequent QUIC packet is to be sent. Thus, UE device 208 may reduce power consumption during the idle period, while also reactivating the reception circuitry at a time when the subsequent QUIC packet is expected to be transmitted.

By placing data representing a time between transmissions (e.g., an idle period or time to next burst (TTNB) value) in an unencrypted portion of a QUIC packet header, sending device 200 may enable intermediate network elements, such as UPF device 202 and base station 206, to access traffic timing characteristics without requiring access to encryption keys or performing decryption. This visibility may allow base station 206 to optimize radio resource scheduling and power saving configurations for UE device 208 based on the actual traffic pattern. For instance, determining the idle period may allow UE device 208 to disable reception circuitry for a maximized duration between bursts, thereby conserving battery power, compared to relying on static inactivity timers. Furthermore, explicitly signaling the lower bound on the time between packets allows the system to accommodate variable encoding delays, such as those inherent in live video transmission, while maintaining efficient delivery and low latency.

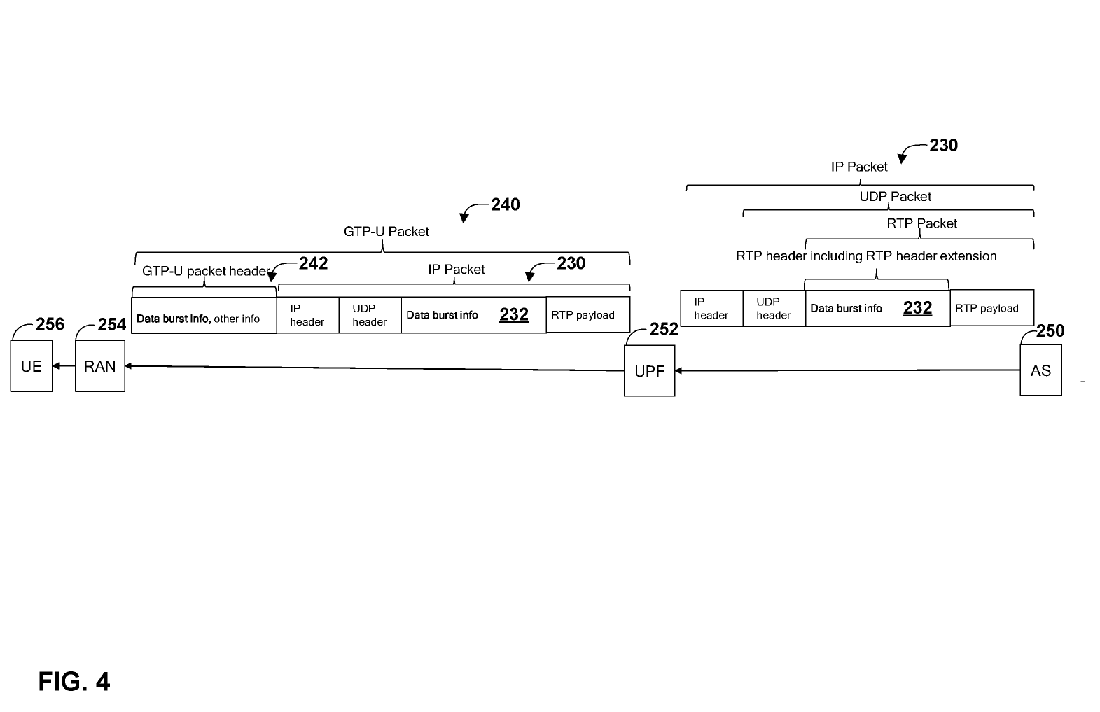

FIG. 4 is a conceptual diagram illustrating packet structures for packets sent between various network devices. For example, FIG. 4 depicts an application server (AS) device 250, which may correspond to sending device 200 of FIG. 3; user plane function (UPF) device 252, which may correspond to UPF device 202 of FIG. 3; a radio access network (RAN) 254, which may include base station 206 and RAN 212 of FIG. 3; and user equipment (UE) device 256, which may correspond to client device 208 of FIG. 3.

Additionally, FIG. 4 depicts an IP packet structure for packets sent by AS device 250 to UPF device 252. In this example, IP packet 230 encapsulates a UDP packet, which encapsulates an RTP packet including an RTP header and RTP header extension and an RTP payload. The RTP packet is encapsulated by a UDP header to form the UDP packet. The UDP packet is encapsulated with an IP header to form the IP packet. In particular, the RTP header extension includes data burst information (info) 232, which may include data representing a burst size of a subsequent data burst and a time between a time at which AS device 250 transmits IP packet 230 and a time at which AS device 250 transmits a subsequent packet (e.g., an ordinal first packet of the subsequent data burst).

UPF device 252 encapsulates IP packet 230 with GTP-U header 242 to form GTP-U packet 240. GTP-U header 242 includes, among other data, data burst information 232 extracted (and potentially modified) from the RTP header and RTP header extension. The base station of RAN 254 may use the data burst information for scheduling reception of GTP-U packets and to inform UE device 256 as to how to schedule reception of forthcoming packet(s).

While FIG. 4 illustrates an example utilizing RTP, the techniques of this disclosure may also apply to QUIC packet flows. In such examples, AS device 250 may generate a QUIC packet (e.g., the previous QUIC packet) including a QUIC header having an unencrypted portion. AS device 250 may include data burst info 232 (e.g., the data representing the time between the time of transmission of the previous QUIC packet and the time of transmission of the subsequent QUIC packet) in the unencrypted portion of the QUIC header. UPF device 252 may extract the data representing the time from the unencrypted portion of the QUIC header and include the data in GTP-U packet header 242. RAN 254 may use this data to configure UE device 256 to disable reception of data for the idle time period defined by the data.

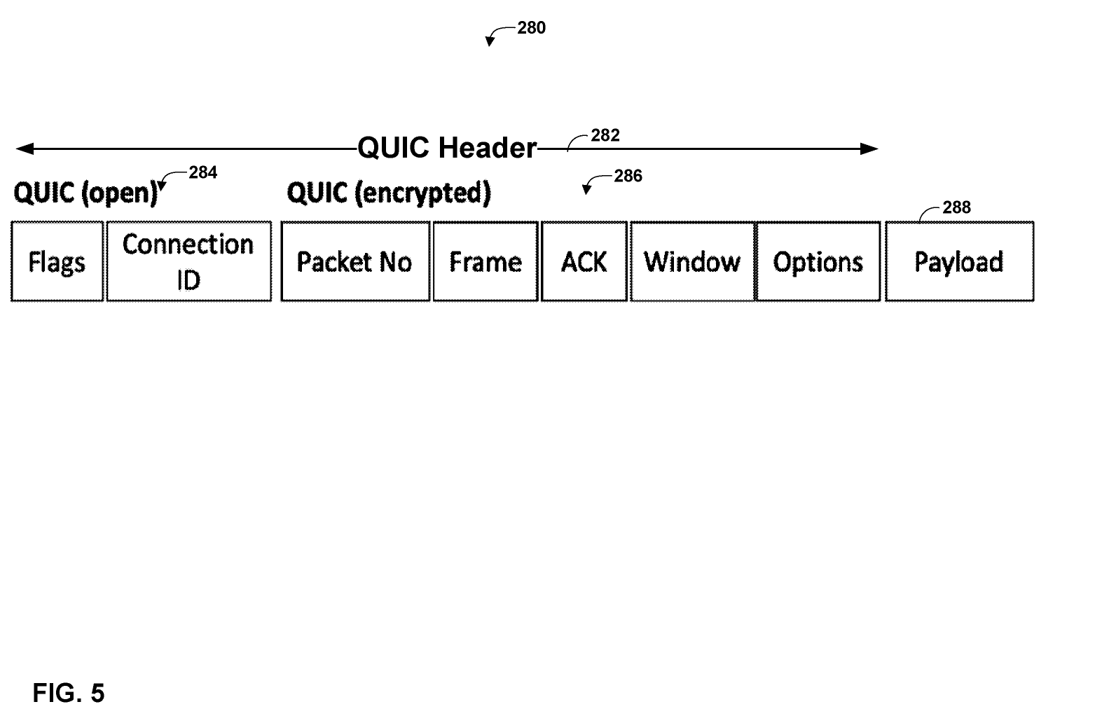

FIG. 5 is a conceptual diagram illustrating example QUIC packet 280. This packet may be referred to as a “1-RTT QUIC packet.” QUIC packet 280 includes QUIC header 282 and payload 288. Payload 288 may include media data, such as encoded video data, encoded audio data, timed text data, extended reality (XR) data such as augmented reality (AR) data, mixed reality (MR) data, and/or virtual reality (VR) data, or other such media data.

As shown in FIG. 5, QUIC header 282 includes open portion 284 (labeled “QUIC (open)”), which may also be referred to as an “unencrypted portion,” and encrypted data 286 (labeled “QUIC (encrypted)”). In QUIC header 282, per conventional QUIC techniques, only the flags and Connection ID are unencrypted, as shown in FIG. 5. The flags may include 3 unencrypted bits in a 1-RTT packet format: Header Form (1) = 0; Fixed Bit (1) = 1; and Spin Bit (1). The spin bit need not be encrypted, because it has been determined that the spin bit does not leak any information to the network.

In accordance with the techniques of this disclosure, QUIC packet 280 may be extended to include data representing a time between a time of transmission of a current QUIC packet (e.g., QUIC packet 280) and a time of transmission of a subsequent QUIC packet (e.g., an ordinal first packet of a subsequent data burst). A sending device may place this data within open portion 284 of QUIC header 282, such that the data is unencrypted. This arrangement may allow network devices to read the data without decrypting encrypted portion 286. In some examples, the data representing the time precedes encrypted portion 286. The data may define an idle time period representing a lower bound on the time between the time of transmission of the previous QUIC packet and the time of transmission of the subsequent QUIC packet, or a time to next burst (TTNB) value. Additionally, a sending device may set a flag bit within the flags of open portion 284 to a value indicating that the data representing the time is present in QUIC packet 280.

This disclosure recognizes that inclusion of burst information (e.g., burst size, TTNB, and/or idle period signaling) does not leak any sensitive information into the network. Therefore, this disclosure recognizes benefits of exposing the burst information to the network. This is because network devices can observe times of arrival of QUIC packets, from which the network devices can derive the TTNB or idle period. The network devices can also observe sizes of QUIC packets, from which the network devices can derive burst size information. Thus, open signaling of the burst information does not disclose information that network devices cannot derive on their own. As such, there is no need to protect (e.g., encrypt) burst information.

Furthermore, while network devices may eventually derive traffic characteristics by observing packet sizes and arrival times, such derivation generally requires observing a plurality of packets over time, resulting in a processing delay (latency). By explicitly signaling the burst information in open portion 284, the network devices may obtain the traffic characteristic data immediately upon receipt of the packet containing the indication (e.g., the first packet of a data burst). This enables immediate resource scheduling or power saving determinations, without the delay inherent in heuristic derivation methods.

In some examples, data representing a time between a time of transmission of QUIC packet 280 and a time of transmission of a subsequent QUIC packet may precede encrypted portion 286 of QUIC packet 280. Additionally, the flags within open portion 284 may include a flag bit having a value indicating that the data representing the time between the time of transmission of the previous QUIC packet and the time of transmission of the subsequent QUIC packet is present in QUIC packet 280. The data representing the time may define an idle time period representing a lower bound on the time between the time of transmission of the previous QUIC packet and the time of transmission of the subsequent QUIC packet, or a time to next burst (TTNB) value.

In some examples, the data representing the time and the burst size data immediately follow the Connection ID field within open portion 284 of QUIC header 282. These unencrypted fields being after the Connection ID and before encrypted portion 286 may allow network devices to easily access this data for parsing and traffic analysis without requiring decryption keys or performance of a decryption process.

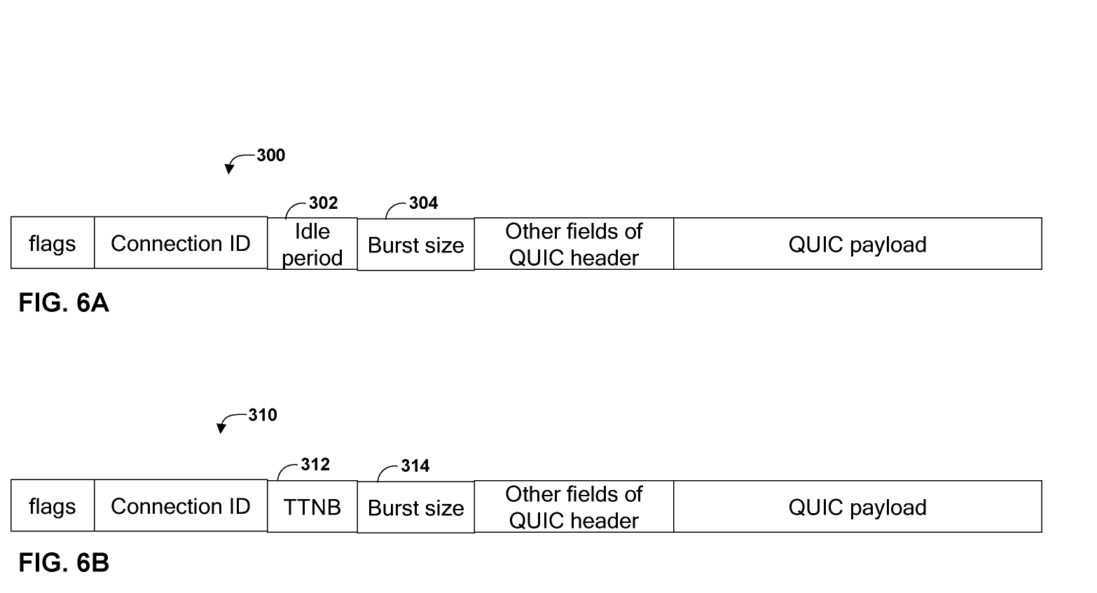

FIGS. 6A and 6B are conceptual diagrams illustrating examples of modified QUIC packets 300, 310 for signaling data burst information per techniques of this disclosure. A sending device (such as AS device 250 of FIG. 4) may add burst information (e.g., burst size data 304, 314) fields to the QUIC header and leave the burst information fields unencrypted. Burst size data 304, 314 may include a unit of the burst size value in bytes and signal the number of bits/bytes.

In some examples, the burst size data 304, 314 include data representing the size of the current data burst. For instance, the sending device may determine an aggregated size of packets comprising the current data burst and signal this total size in the ordinal first packet of the current data burst. This allows network devices to schedule sufficient resources for traffic of the current burst. Alternatively, or additionally, the burst size data 304, 314 may represent the estimated or known size of a subsequent data burst.

The sending device may also signal timing information for the burst. In the example of FIG. 6A, the timing information is idle period data 302. The unit for the idle period information may be a fraction of a millisecond and number of bits may be Y. In the example of FIG. 6B, the timing information is TTNB value 312. The unit for the TTNB information may be a fraction of a millisecond and the number of bits may be Y. The other QUIC header fields shown in FIGS. 6A and 6B may include packet number, frame number, acknowledgement (ACK), window, and options data, as shown in FIG. 5. In some examples, the unit for idle period data 302 or TTNB value 312 may be defined as 1/8 of a millisecond. Alternatively, other fractions of a millisecond or time units suitable for the specific network radio access technology may be used.

The presence of the burst information may be indicated by the “Flags” field of FIGS. 6A and 6B. That is, the Flags field may include an additional unencrypted bit indicating whether the burst information is present. For example, if the QUIC sending device is to indicate the burst information is present in a QUIC packet, the sending device may set the bit to a value of 1, and otherwise to a value of 0 to indicate that no burst information is present. Setting of this bit may be dynamic, e.g., on a per packet basis. That is, the QUIC sending device may send burst information for some, but not all, QUIC packets of a packet flow.

In one example, the QUIC sending device sets the flag bit to indicate the presence of burst information only in a first packet of a data burst. Subsequent packets belonging to the same data burst may have the flag bit set to 0 and exclude the burst information fields. This approach may provide the scheduling and timing information to the network and receiving device at the onset of the data burst, while avoiding increased header overhead for the remaining packets in the burst.

When the idle period is unknown to the traffic source when the indication is put in the QUIC packet header, the traffic source can indicate in the QUIC packet that the idle period is unknown. In some examples, a dedicated bit, e.g., a reserved bit, may be used to indicate that the idle period is unknown. In some examples, a reserved value, e.g., all bits of the idle period field being set to 1, may be used to indicate that the idle period is unknown. The same techniques may also apply to TTNB values. Specifically, when the TTNB is unknown to the traffic source when the indication is put in the QUIC packet, the traffic source can indicate in the QUIC packet that the TTNB is unknown. In some examples, a dedicated bit, e.g., a reserved bit, is used to indicate that the TTNB is unknown. In some examples, a reserved value, e.g., all bits of the TTNB field being set to 1, may be used to indicate that the TTNB is unknown.

When the idle period is unknown to the traffic source when the indication is put in the RTP packet header, the traffic source can indicate in the RTP packet header that the idle period is unknown. In some examples, a dedicated bit, e.g., a reserved bit, is used to indicate that the idle period is unknown. In some examples, a reserved value, e.g., all bits of the idle period field being set to 1, may be used to indicate that the idle period is unknown. The same technique may apply to the TTNB value. Specifically, when the TTNB is unknown to the traffic source when the indication is put in the RTP packet, the traffic source can indicate in the RTP packet that the TTNB is unknown. In some examples, a dedicated bit, e.g., a reserved bit, may be used to indicate that the TTNB is unknown. In some examples, a reserved value, e.g., all bits of the TTNB field being set to 1, may be used to indicate that the TTNB is unknown.

In this manner, the sending device, the UPF device, the base station, and the client/UE device may use the data burst information as explained above with respect to FIG. 3, but as applied to QUIC packets as opposed to RTP packets. Therefore, the techniques of this disclosure may be used to signal burst information (e.g., TTNB, idle period, or other lower bound on a time between bursts/packets) when QUIC is used to transport data, such as encoded video data.

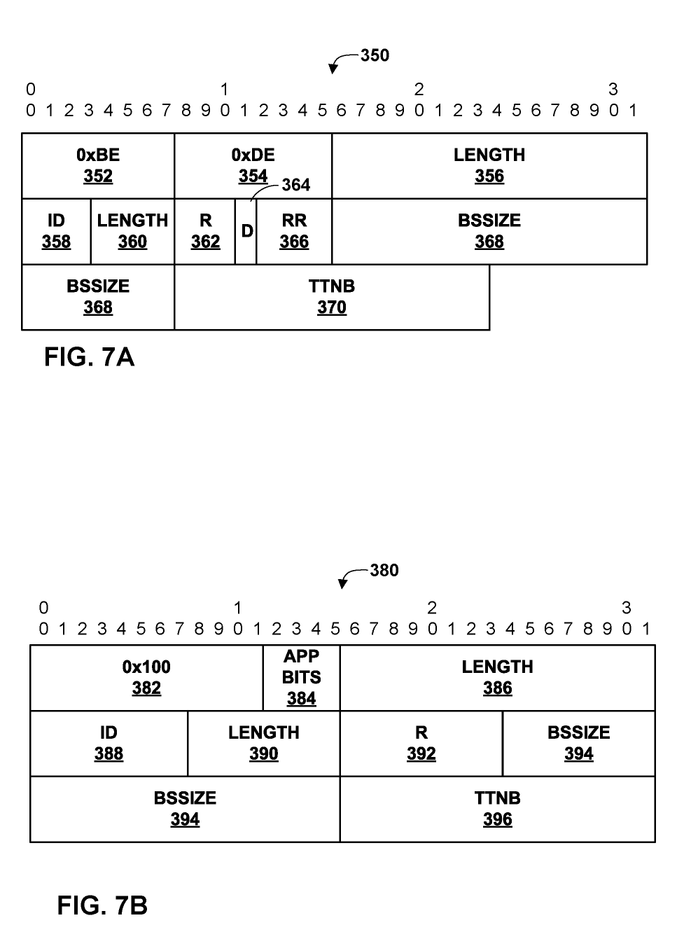

FIGS. 7A and 7B are conceptual diagrams illustrating example RTP header extensions for signaling dynamically changing traffic characteristic indications for one- and two-byte RTP header extension formats. In the example of FIG. 7A, RTP header extension 350 includes two preliminary 8-bit fields of 0xBE 352 and 0xDE 354, 16-bit length field 356, four-bit ID field 358, four-bit length (len) field 360, three-bit R field 362, one-bit D field 364, four-bit RR field 366, 24-bit BSSize field 368, and 16-bit TTNB field 370. In the example of FIG. 7B, RTP header extension 380 includes preliminary 12-bit 0x100 field 382, 4-bit application bits (app bits) field 384, 16-bit length field 386, eight-bit ID field 388, eight-bit length (len) field 390, eight-bit R field 392, 24-bit BSSize field 394, and 16-bit TTNB field 396.

By providing a compact one-byte format, such as RTP header extension 350, a sending device may minimize overhead when signaling frequently changing burst information, thereby improving transmission efficiency. Alternatively, the two-byte format of RTP header extension 380 may allow for greater extensibility and precision when required. Implementing these efficient signaling structures, or functionally similar unencrypted fields within a QUIC header, may enable intermediate network devices to extract burst size and timing data with minimal processing latency. This accessibility may facilitate timely cross-layer optimization, such as resource scheduling and power saving, even when the packet payload remains encrypted.

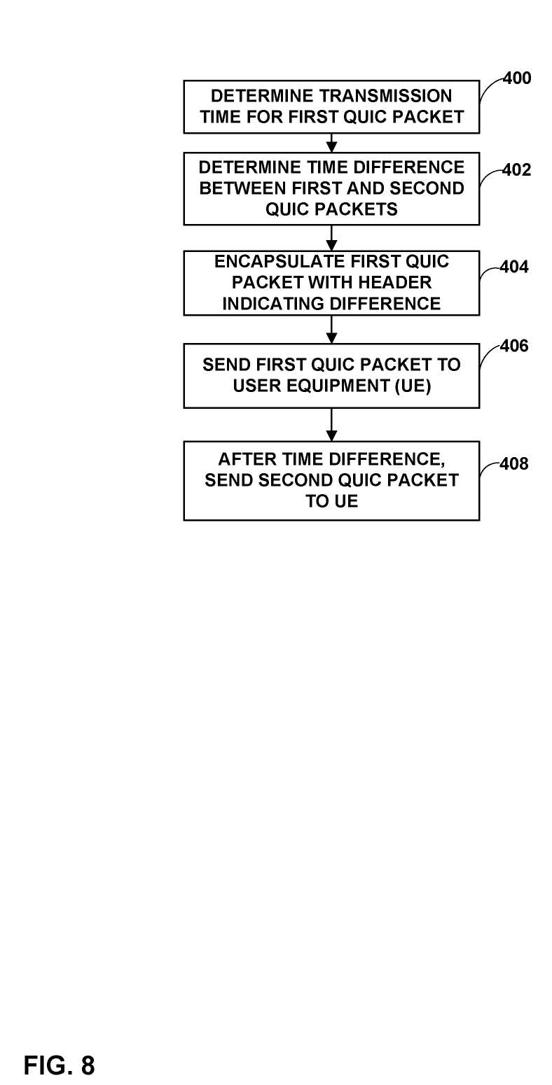

FIG. 8 is a flowchart illustrating an example method of constructing and sending a QUIC packet including a QUIC packet header extension per techniques of this disclosure. The method of FIG. 8 is described with respect to sending device 200 (FIG. 3). However, other devices, such as server device 60 (FIG. 1), content preparation device 20 (FIG. 1), or application server (AS) 250 (FIG. 4), may perform the method of FIG. 8.

Initially, sending device 200 determines a transmission time for a first QUIC packet (400). The first QUIC packet may correspond to a QUIC packet of a QUIC packet flow. The first QUIC packet may be an ordinal first packet of a current data burst.

Sending device 200 also determines a time difference between the transmission time of the first QUIC packet and a transmission time of a second QUIC packet (402). The second QUIC packet corresponds to a subsequent QUIC packet of the QUIC packet flow. The second QUIC packet may correspond to an ordinal first QUIC packet of a next data burst that immediately follows the current data burst.

In some examples, sending device 200 calculates the time between the time of transmission of the first QUIC packet and the time of transmission of the second QUIC packet according to a video encoding delay. For instance, the first QUIC packet may include encoded video data of a media presentation, and the second QUIC packet may include encoded video data of the media presentation. Sending device 200 may determine the video encoding delay based on encoding complexity, scene changes, or other factors affecting the video encoder.

Sending device 200 encapsulates the first QUIC packet with a header indicating the time difference (i.e., the time between the time of transmission of the first QUIC packet and the time of transmission of the second QUIC packet) (404). Sending device 200 sends data representing the time between the time of transmission of the first QUIC packet and the time of transmission of the second QUIC packet to the client device (e.g., UE device 208). Sending device 200 may send the data representing the time in an unencrypted portion of a QUIC header of the first QUIC packet. The data may define an idle time period representing a lower bound on the time between the time of transmission of the first QUIC packet and the time of transmission of the second QUIC packet. Alternatively, the data representing the time may define a time to next burst (TTNB) value. The TTNB value may represent a precise time between the time of transmission of the first QUIC packet and the time of transmission of the second QUIC packet. In other examples, the TTNB value represents a lower bound on the time between the time of transmission of the first QUIC packet and the time of transmission of the second QUIC packet.

Sending device 200 sends the first QUIC packet to a destination device, such as user equipment (UE) device 208 of FIG. 3 (406). At or after a time corresponding to the time following the time of transmission of the first QUIC packet (e.g., after the time difference), sending device 200 sends the second QUIC packet to the UE (408). In some examples, sending device 200 may send the second QUIC packet at the precise time indicated by the time difference (e.g., when the time difference is represented by a TTNB value). In some examples, sending device 200 may send the QUIC packet at a time at or after the time indicated by the time difference (e.g., when the time difference is represented by an idle period value that represents a minimum or lower bound time during which no packets are sent).

In this manner, the method of FIG. 8 represents an example of a method of sending data via a network, including: sending a previous QUIC packet of a QUIC packet flow to a client device; determining a time between a time of transmission of the previous QUIC packet and a time of transmission of a subsequent QUIC packet of the QUIC packet flow; sending data representing the time between the time of transmission of the previous QUIC packet and the time of transmission of the subsequent QUIC packet to the client device; and at or after a time corresponding to a time following the time between the time of transmission of the previous QUIC packet and the time of transmission of the subsequent QUIC packet, sending the subsequent QUIC packet to the client device.

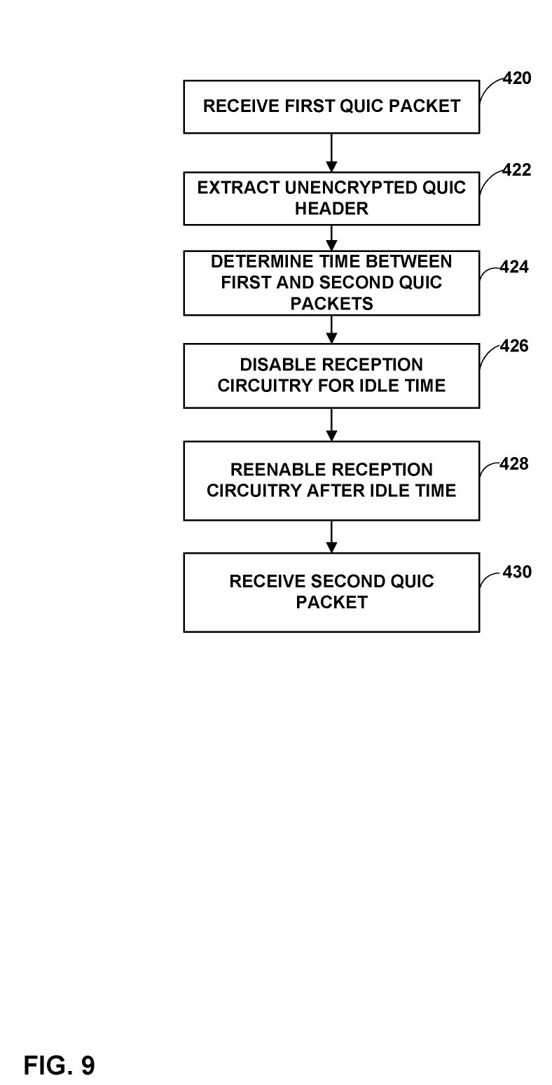

FIG. 9 is a flowchart illustrating an example method of receiving and using a QUIC packet including a QUIC packet header extended per techniques of this disclosure. The method of FIG. 9 is described with respect to UE device 208 (FIG. 3). However, other devices, such as client device 40 (FIG. 1) or UE device 256 (FIG. 4), may perform the method of FIG. 9.

Initially, UE device 208 receives a first QUIC packet (420). The first QUIC packet corresponds to a QUIC packet of a QUIC packet flow. For example, the first QUIC packet may be an ordinal first packet of a current data burst of the QUIC packet flow. UE device 208 extracts an unencrypted QUIC header from the first QUIC packet (422). As noted above, the unencrypted QUIC header may include data representing a time between a time of transmission of the previous QUIC packet and a time of transmission of a subsequent QUIC packet, per the techniques of this disclosure. In some examples, a flag bit in the first QUIC packet indicates the presence of this data.

UE device 208 determines the time between the time of transmission of the first QUIC packet and the time of transmission of a second QUIC packet (424). The second QUIC packet corresponds to a subsequent QUIC packet of the QUIC packet flow, e.g., an ordinal first packet of a subsequent data burst of the QUIC packet flow. The data representing the time difference may define an idle time period as a lower bound on or minimum of the time between transmissions. Alternatively, the data representing the time difference may be a time to next burst (TTNB) value. The TTNB value may represent a precise time or a lower bound on the time. In some examples, a base station (e.g., base station 206 of FIG. 3) may extract the time between the time of transmission of the first QUIC packet and the time of transmission of the second QUIC packet and configure UE device 208 to enter a low power mode during that time.

UE device 208 then disables reception circuitry for an idle time period according to the determined time (426). For example, UE device 208 may power down radio components or enter a sleep mode. After the idle time period, UE device 208 reenables the reception circuitry (428). UE device 208 then receives the second QUIC packet (430). In some examples, UE device 208 receives the second QUIC packet at a time later than the time at which reception of data is enabled following the idle time period. UE device 208 may also receive burst size information for the subsequent QUIC packet, which may be included in the unencrypted header of the first QUIC packet. Additionally, UE device 208 may receive a flag bit in the second QUIC packet indicating that the second QUIC packet does not include burst information.

In this manner, the method of FIG. 9 represents an example of a method of receiving data via a network, including: receiving data representing a time between a time of transmission of a previous QUIC packet and a time of transmission of a subsequent QUIC packet; after receiving the previous QUIC packet, disabling reception of data for an idle time period according to the data representing the time between the time of transmission of the previous QUIC packet and the time of transmission of the subsequent QUIC packet; after the idle time period, enabling reception of data; and after enabling reception of data, receiving the subsequent QUIC packet.

Various examples of the techniques of this disclosure are summarized in the following clauses:

Clause 1. A method of receiving data via a network, the method comprising: receiving data representing a time between a time of transmission of a previous QUIC packet and a time of transmission of a subsequent QUIC packet; after receiving the previous QUIC packet, disabling reception of data for an idle time period according to the data representing the time between the time of transmission of the previous QUIC packet and the time of transmission of the subsequent QUIC packet; after the idle time period, enabling reception of data; and after enabling reception of data, receiving the subsequent QUIC packet.

Clause 2. The method of clause 1, wherein the data representing the time between the time of transmission of the previous QUIC packet and the time of transmission of the subsequent QUIC packet comprises data defining the idle time period as a lower bound on the time between the time of transmission of the previous QUIC packet and the time of transmission of the subsequent QUIC packet.

Clause 3. The method of clause 1, wherein the data representing the time between the time of transmission of the previous QUIC packet and the time of transmission of the subsequent QUIC packet comprises data defining a time to next burst (TTNB) value.

Clause 4. The method of clause 3, wherein the TTNB value represents a precise time between the time of transmission of the previous QUIC packet and the time of transmission of the subsequent QUIC packet.

Clause 5. The method of clause 3, wherein the TTNB value represents a lower bound on the time between the time of transmission of the previous QUIC packet and the time of transmission of the subsequent QUIC packet.

Clause 6. The method of any of clauses 1–5, further comprising receiving burst size information for the subsequent QUIC packet.

Clause 7. The method of any of clauses 1–6, wherein the data representing the time between the time of transmission of the previous QUIC packet and the time of transmission of the subsequent QUIC packet is unencrypted and precedes an encrypted portion of the previous QUIC packet.

Clause 8. The method of any of clauses 1–7, further comprising receiving a flag bit having a value indicating that the data representing the time between the time of transmission of the previous QUIC packet and the time of transmission of the subsequent QUIC packet is present in the previous QUIC packet.

Clause 9. The method of clause 8, further comprising receiving a flag bit of the subsequent QUIC packet having a value indicating that the subsequent QUIC packet does not include burst information.

Clause 10. The method of any of clauses 1–9, wherein receiving the subsequent QUIC packet comprises receiving the subsequent QUIC packet at a time later than the time at which reception of data is enabled following the idle time period.

Clause 11. A method of sending data via a network, the method comprising: sending a previous QUIC packet of a QUIC packet flow to a client device; determining a time between a time of transmission of the previous QUIC packet and a time of transmission of a subsequent QUIC packet of the packet flow; sending data representing the time between the time of transmission of the previous QUIC packet and the time of transmission of the subsequent QUIC packet to the client device; and at or after a time corresponding to the time following the time of transmission of the previous QUIC packet, sending the subsequent QUIC packet to the client device.

Clause 12. The method of clause 11, wherein sending the data representing the time between the time of transmission of the previous QUIC packet and the time of transmission of the subsequent QUIC packet comprises sending the data representing the time between the time of transmission of the previous QUIC packet and the time of transmission of the subsequent QUIC packet in an unencrypted portion of a QUIC header of the previous QUIC packet.

Clause 13. The method of any of clauses 11 and 12, wherein the data representing the time between the time of transmission of the previous QUIC packet and the time of transmission of the subsequent QUIC packet comprises data defining an idle time period representing a lower bound on the time between the time of transmission of the previous QUIC packet and the time of transmission of the subsequent QUIC packet.

Clause 14. The method of any of clauses 11 and 12, wherein the data representing the time between the time of transmission of the previous QUIC packet and the time of transmission of the subsequent QUIC packet comprises data defining a time to next burst (TTNB) value.

Clause 15. The method of clause 14, wherein the TTNB value represents a precise time between the time of transmission of the previous QUIC packet and the time of transmission of the subsequent QUIC packet.

Clause 16. The method of clause 14, wherein the TTNB value represents a lower bound on the time between the time of transmission of the previous QUIC packet and the time of transmission of the subsequent QUIC packet.

Clause 17. The method of any of clauses 11–16, further comprising calculating the time between the time of transmission of the previous QUIC packet and the time of transmission of the subsequent QUIC packet according to a video encoding delay, wherein the previous QUIC packet includes encoded video data of a media presentation and the subsequent QUIC packet comprises encoded video data of the media presentation.

Clause 18. A device for receiving data via a network, the device comprising one or more means for performing the method of any of clauses 1–17.

Clause 19. The device of clause 18, wherein the one or more means comprise a memory and a processing system implemented in circuitry.

Clause 20. The device of clause 18, wherein the device comprises at least one of: an integrated circuit; a microprocessor; and a wireless communication device.

Clause 21. A device for retrieving media data, the device comprising: means for receiving data representing a time between a time of transmission of a previous QUIC packet and a time of transmission of a subsequent QUIC packet; means for, after reception of the previous QUIC packet, disabling reception of data for an idle time period according to the data representing the time between the time of transmission of the previous QUIC packet and the time of transmission of the subsequent QUIC packet; means for, after the idle time period, enabling reception of data; and means for, after enabling reception of data, receiving the subsequent QUIC packet.

Clause 22. A device for sending data via a network, the device comprising: means for sending a previous QUIC packet of a packet flow to a client device; means for determining a time between a time of transmission of the previous QUIC packet and a time of transmission of a subsequent QUIC packet of the packet flow; means for sending data representing the time between the time of transmission of the previous QUIC packet and the time of transmission of the subsequent QUIC packet to the client device; and means for, at or after a time corresponding to the time following the time of transmission of the previous QUIC packet, sending the subsequent QUIC packet to the client device.

Clause 23. A method of receiving data via a network, the method comprising: receiving data representing a time between a time of transmission of a previous QUIC packet and a time of transmission of a subsequent QUIC packet; after receiving the previous QUIC packet, disabling reception of data for an idle time period according to the data representing the time between the time of transmission of the previous QUIC packet and the time of transmission of the subsequent QUIC packet; after the idle time period, enabling reception of data; and after enabling reception of data, receiving the subsequent QUIC packet.

Clause 24. The method of clause 23, wherein the data representing the time between the time of transmission of the previous QUIC packet and the time of transmission of the subsequent QUIC packet comprises data defining the idle time period as a lower bound on the time between the time of transmission of the previous QUIC packet and the time of transmission of the subsequent QUIC packet.

Clause 25. The method of clause 23, wherein the data representing the time between the time of transmission of the previous QUIC packet and the time of transmission of the subsequent QUIC packet comprises data defining a time to next burst (TTNB) value.

Clause 26. The method of clause 25, wherein the TTNB value represents a precise time between the time of transmission of the previous QUIC packet and the time of transmission of the subsequent QUIC packet.

Clause 27. The method of clause 25, wherein the TTNB value represents a lower bound on the time between the time of transmission of the previous QUIC packet and the time of transmission of the subsequent QUIC packet.

Clause 28. The method of any of clauses 23–27, further comprising receiving burst size information for a subsequent data burst including the subsequent QUIC packet.

Clause 29. The method of any of clauses 23–28, wherein the data representing the time between the time of transmission of the previous QUIC packet and the time of transmission of the subsequent QUIC packet is unencrypted.

Clause 30. The method of any of clauses 23–29, wherein the data representing the time between the time of transmission of the previous QUIC packet and the time of transmission of the subsequent QUIC packet precedes an encrypted portion of the previous QUIC packet.

Clause 31. The method of any of clauses 23–30, further comprising receiving a flag bit having a value indicating that the data representing the time between the time of transmission of the previous QUIC packet and the time of transmission of the subsequent QUIC packet is present in the previous QUIC packet.

Clause 32. The method of clause 31, further comprising receiving a flag bit of the subsequent QUIC packet having a value indicating that the subsequent QUIC packet does not include burst information.

Clause 33. The method of any of clauses 23–32, wherein receiving the subsequent QUIC packet comprises receiving the subsequent QUIC packet at a time later than the time at which reception of data is enabled following the idle time period.

Clause 34. A device for receiving data via a network, the device comprising: a memory configured to store data; and a processing system implemented in circuitry, the processing system including reception circuitry, the processing system being configured to: receive, via the reception circuitry, data representing a time between a time of transmission of a previous QUIC packet and a time of transmission of a subsequent QUIC packet; after receiving the previous QUIC packet, disable the reception circuitry for an idle time period according to the data representing the time between the time of transmission of the previous QUIC packet and the time of transmission of the subsequent QUIC packet; after the idle time period, enable the reception circuitry; and after enabling the reception circuitry, receive, via the reception circuitry, the subsequent QUIC packet.

Clause 35. The device of clause 34, wherein the data representing the time between the time of transmission of the previous QUIC packet and the time of transmission of the subsequent QUIC packet comprises one of: data defining the idle time period as a lower bound on the time between the time of transmission of the previous QUIC packet and the time of transmission of the subsequent QUIC packet, or data defining a time to next burst (TTNB) value.

Clause 36. The device of any of clauses 34 and 35, wherein the data representing the time between the time of transmission of the previous QUIC packet and the time of transmission of the subsequent QUIC packet is unencrypted.

Clause 37. The device of any of clauses 34–36, wherein the previous QUIC packet includes a flag bit having a value indicating that the data representing the time between the time of transmission of the previous QUIC packet and the time of transmission of the subsequent QUIC packet is present in the previous QUIC packet.

Clause 38. The device of any of clauses 34–37, wherein the processing system receives the subsequent QUIC packet at a time later than the time at which the reception circuitry is enabled following the idle time period.

Clause 39. A method of sending data via a network, the method comprising: sending a previous QUIC packet of a QUIC packet flow to a client device; determining a time between a time of transmission of the previous QUIC packet and a time of transmission of a subsequent QUIC packet of the QUIC packet flow; sending data representing the time between the time of transmission of the previous QUIC packet and the time of transmission of the subsequent QUIC packet to the client device; and at or after a time corresponding to a time following the time between the time of transmission of the previous QUIC packet and the time of transmission of the subsequent QUIC packet, sending the subsequent QUIC packet to the client device.

Clause 40. The method of clause 39, wherein sending the data representing the time between the time of transmission of the previous QUIC packet and the time of transmission of the subsequent QUIC packet comprises sending the data representing the time between the time of transmission of the previous QUIC packet and the time of transmission of the subsequent QUIC packet in an unencrypted portion of a QUIC header of the previous QUIC packet.

Clause 41. The method of any of clauses 39 and 40, wherein the data representing the time between the time of transmission of the previous QUIC packet and the time of transmission of the subsequent QUIC packet comprises data defining an idle time period representing a lower bound on the time between the time of transmission of the previous QUIC packet and the time of transmission of the subsequent QUIC packet.

Clause 42. The method of any of clauses 39 and 40, wherein the data representing the time between the time of transmission of the previous QUIC packet and the time of transmission of the subsequent QUIC packet comprises data defining a time to next burst (TTNB) value.

Clause 43. The method of clause 42, wherein the TTNB value represents a precise time between the time of transmission of the previous QUIC packet and the time of transmission of the subsequent QUIC packet.

Clause 44. The method of clause 42, wherein the TTNB value represents a lower bound on the time between the time of transmission of the previous QUIC packet and the time of transmission of the subsequent QUIC packet.

Clause 45. The method of any of clauses 39–44, further comprising calculating the time between the time of transmission of the previous QUIC packet and the time of transmission of the subsequent QUIC packet according to a video encoding delay, wherein the previous QUIC packet includes encoded video data of a media presentation and the subsequent QUIC packet comprises encoded video data of the media presentation.

Clause 46. A device for sending data via a network, the device comprising: a memory configured to store data; and a processing system implemented in circuitry and configured to: send a previous QUIC packet of a QUIC packet flow to a client device; determine a time between a time of transmission of the previous QUIC packet and a time of transmission of a subsequent QUIC packet of the QUIC packet flow; send data representing the time between the time of transmission of the previous QUIC packet and the time of transmission of the subsequent QUIC packet to the client device; and at or after a time corresponding to a time following the time between the time of transmission of the previous QUIC packet and the time of transmission of the subsequent QUIC packet, send the subsequent QUIC packet to the client device.

Clause 47. The device of clause 46, wherein to send the data representing the time between the time of transmission of the previous QUIC packet and the time of transmission of the subsequent QUIC packet, the processing system is configured to send the data representing the time between the time of transmission of the previous QUIC packet and the time of transmission of the subsequent QUIC packet in an unencrypted portion of a QUIC header of the previous QUIC packet.

Clause 48. The device of any of clauses 46 and 47, wherein the data representing the time between the time of transmission of the previous QUIC packet and the time of transmission of the subsequent QUIC packet comprises data defining an idle time period representing a lower bound on the time between the time of transmission of the previous QUIC packet and the time of transmission of the subsequent QUIC packet.

Clause 49. The device of any of clauses 46 and 47, wherein the data representing the time between the time of transmission of the previous QUIC packet and the time of transmission of the subsequent QUIC packet comprises data defining a time to next burst (TTNB) value.

Clause 50. The device of clause 49, wherein the TTNB value represents a precise time between the time of transmission of the previous QUIC packet and the time of transmission of the subsequent QUIC packet.

Clause 51. The device of clause 49, wherein the TTNB value represents a lower bound on the time between the time of transmission of the previous QUIC packet and the time of transmission of the subsequent QUIC packet.

Clause 52. The device of any of clauses 46–51, wherein the processing system is further configured to calculate the time between the time of transmission of the previous QUIC packet and the time of transmission of the subsequent QUIC packet according to a video encoding delay, wherein the previous QUIC packet includes encoded video data of a media presentation and the subsequent QUIC packet comprises encoded video data of the media presentation.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of receiving data via a network, the method comprising:
receiving data representing a time between a time of transmission of a previous QUIC packet and a time of transmission of a subsequent QUIC packet;
after receiving the previous QUIC packet, disabling reception of data for an idle time period according to the data representing the time between the time of transmission of the previous QUIC packet and the time of transmission of the subsequent QUIC packet;
after the idle time period, enabling reception of data; and
after enabling reception of data, receiving the subsequent QUIC packet.

2. The method of claim 1, wherein the data representing the time between the time of transmission of the previous QUIC packet and the time of transmission of the subsequent QUIC packet comprises data defining the idle time period as a lower bound on the time between the time of transmission of the previous QUIC packet and the time of transmission of the subsequent QUIC packet.

3. The method of claim 1, wherein the data representing the time between the time of transmission of the previous QUIC packet and the time of transmission of the subsequent QUIC packet comprises data defining a time to next burst (TTNB) value.

4. The method of claim 3, wherein the TTNB value represents a precise time between the time of transmission of the previous QUIC packet and the time of transmission of the subsequent QUIC packet.

5. The method of claim 3, wherein the TTNB value represents a lower bound on the time between the time of transmission of the previous QUIC packet and the time of transmission of the subsequent QUIC packet.

6. The method of claim 1, further comprising receiving burst size information for a subsequent data burst including the subsequent QUIC packet.

7. The method of claim 1, wherein the data representing the time between the time of transmission of the previous QUIC packet and the time of transmission of the subsequent QUIC packet is unencrypted.

8. The method of claim 1, wherein the data representing the time between the time of transmission of the previous QUIC packet and the time of transmission of the subsequent QUIC packet precedes an encrypted portion of the previous QUIC packet.

9. The method of claim 1, further comprising receiving a flag bit having a value indicating that the data representing the time between the time of transmission of the previous QUIC packet and the time of transmission of the subsequent QUIC packet is present in the previous QUIC packet.

10. The method of claim 9, further comprising receiving a flag bit of the subsequent QUIC packet having a value indicating that the subsequent QUIC packet does not include burst information.

11. The method of claim 1, wherein receiving the subsequent QUIC packet comprises receiving the subsequent QUIC packet at a time later than the time at which reception of data is enabled following the idle time period.

12. A device for receiving data via a network, the device comprising:
a memory configured to store data; and
a processing system implemented in circuitry, the processing system including reception circuitry, the processing system being configured to:
receive, via the reception circuitry, data representing a time between a time of transmission of a previous QUIC packet and a time of transmission of a subsequent QUIC packet;
after receiving the previous QUIC packet, disable the reception circuitry for an idle time period according to the data representing the time between the time of transmission of the previous QUIC packet and the time of transmission of the subsequent QUIC packet;
after the idle time period, enable the reception circuitry; and
after enabling the reception circuitry, receive, via the reception circuitry, the subsequent QUIC packet.

13. The device of claim 12, wherein the data representing the time between the time of transmission of the previous QUIC packet and the time of transmission of the subsequent QUIC packet comprises one of:
data defining the idle time period as a lower bound on the time between the time of transmission of the previous QUIC packet and the time of transmission of the subsequent QUIC packet, or
data defining a time to next burst (TTNB) value.

14. The device of claim 12, wherein the data representing the time between the time of transmission of the previous QUIC packet and the time of transmission of the subsequent QUIC packet is unencrypted.

15. The device of claim 12, wherein the previous QUIC packet includes a flag bit having a value indicating that the data representing the time between the time of transmission of the previous QUIC packet and the time of transmission of the subsequent QUIC packet is present in the previous QUIC packet.

16. The device of claim 12, wherein the processing system receives the subsequent QUIC packet at a time later than the time at which the reception circuitry is enabled following the idle time period.

17. A method of sending data via a network, the method comprising:
sending a previous QUIC packet of a QUIC packet flow to a client device;
determining a time between a time of transmission of the previous QUIC packet and a time of transmission of a subsequent QUIC packet of the QUIC packet flow;
sending data representing the time between the time of transmission of the previous QUIC packet and the time of transmission of the subsequent QUIC packet to the client device; and
at or after a time corresponding to a time following the time between the time of transmission of the previous QUIC packet and the time of transmission of the subsequent QUIC packet, sending the subsequent QUIC packet to the client device.

18. The method of claim 17, wherein sending the data representing the time between the time of transmission of the previous QUIC packet and the time of transmission of the subsequent QUIC packet comprises sending the data representing the time between the time of transmission of the previous QUIC packet and the time of transmission of the subsequent QUIC packet in an unencrypted portion of a QUIC header of the previous QUIC packet.

19. The method of claim 17, wherein the data representing the time between the time of transmission of the previous QUIC packet and the time of transmission of the subsequent QUIC packet comprises data defining an idle time period representing a lower bound on the time between the time of transmission of the previous QUIC packet and the time of transmission of the subsequent QUIC packet.

20. The method of claim 17, wherein the data representing the time between the time of transmission of the previous QUIC packet and the time of transmission of the subsequent QUIC packet comprises data defining a time to next burst (TTNB) value.

21. The method of claim 20, wherein the TTNB value represents a precise time between the time of transmission of the previous QUIC packet and the time of transmission of the subsequent QUIC packet.

22. The method of claim 20, wherein the TTNB value represents a lower bound on the time between the time of transmission of the previous QUIC packet and the time of transmission of the subsequent QUIC packet.

23. The method of claim 17, further comprising calculating the time between the time of transmission of the previous QUIC packet and the time of transmission of the subsequent QUIC packet according to a video encoding delay, wherein the previous QUIC packet includes encoded video data of a media presentation and the subsequent QUIC packet comprises encoded video data of the media presentation.

24. A device for sending data via a network, the device comprising:
a memory configured to store data; and
a processing system implemented in circuitry and configured to:
send a previous QUIC packet of a QUIC packet flow to a client device;
determine a time between a time of transmission of the previous QUIC packet and a time of transmission of a subsequent QUIC packet of the QUIC packet flow;
send data representing the time between the time of transmission of the previous QUIC packet and the time of transmission of the subsequent QUIC packet to the client device; and
at or after a time corresponding to a time following the time between the time of transmission of the previous QUIC packet and the time of transmission of the subsequent QUIC packet, send the subsequent QUIC packet to the client device.

25. The device of claim 24, wherein to send the data representing the time between the time of transmission of the previous QUIC packet and the time of transmission of the subsequent QUIC packet, the processing system is configured to send the data representing the time between the time of transmission of the previous QUIC packet and the time of transmission of the subsequent QUIC packet in an unencrypted portion of a QUIC header of the previous QUIC packet.

26. The device of claim 24, wherein the data representing the time between the time of transmission of the previous QUIC packet and the time of transmission of the subsequent QUIC packet comprises data defining an idle time period representing a lower bound on the time between the time of transmission of the previous QUIC packet and the time of transmission of the subsequent QUIC packet.

27. The device of claim 24, wherein the data representing the time between the time of transmission of the previous QUIC packet and the time of transmission of the subsequent QUIC packet comprises data defining a time to next burst (TTNB) value.

28. The device of claim 27, wherein the TTNB value represents a precise time between the time of transmission of the previous QUIC packet and the time of transmission of the subsequent QUIC packet.

29. The device of claim 27, wherein the TTNB value represents a lower bound on the time between the time of transmission of the previous QUIC packet and the time of transmission of the subsequent QUIC packet.

30. The device of claim 24, wherein the processing system is further configured to calculate the time between the time of transmission of the previous QUIC packet and the time of transmission of the subsequent QUIC packet according to a video encoding delay, wherein the previous QUIC packet includes encoded video data of a media presentation and the subsequent QUIC packet comprises encoded video data of the media presentation.
